(19) United States
(12) Patent Application Publication
(10) Pub. No.: US 2025/0216846 A1
(43) Pub. Date: Jul. 3, 2025

(54) Method and Apparatus for Calculating Remaining Useful Life of Electronic System

(71) Applicant: Siemens Aktiengesellschaft, München (DE)

(72) Inventors: Zhen Liu, Shanghai (CN); Jian Guo Pang, Shanghai (CN); Wei Gang Chen, Shanghai (CN)

(73) Assignee: Siemens Aktiengesellschaft, München (DE)

(21) Appl. No.: 18/851,385

(22) PCT Filed: Mar. 30, 2022
(86) PCT No.: PCT/CN2022/084067

§ 371 Date: Sep. 26, 2024

(51) Int. Cl. G05B 23/02

(52) U.S. Cl. CPC G05B 23/0283

(57) ABSTRACT

Various embodiments of the teachings herein include methods for calculating the remaining useful life of an electronic system. An example includes: determining multiple degradation distribution models of the electronic system using historical data for a multiplicity of electronic units representing a degradation level of the electronic system; processing the historical data using a proportional hazards degradation model to obtain a reliability function for the electronic units; using real-time test data to perform calculation using a corresponding degradation distribution model to obtain a degradation index value for the electronic units; and using the degradation index value to calculate the remaining useful life of the electronic system using the reliability function and the current test time point.

### CROSS-REFERENCE TO RELATED APPLICATIONS

This application is a U.S. National Stage Application of International Application No. PCT/CN2022/084067 filed Mar. 30, 2022, which designates the United States of America, the contents of which are hereby incorporated by reference in their entirety.

### TECHNICAL FIELD

The content of the present disclosure relates to electronic systems. Various embodiments of the teachings herein include methods and/or apparatus for calculating the remaining useful life of an electronic system.

### BACKGROUND

Predictive maintenance or state-based maintenance of an electronic system includes diagnostic assessment of factors such as the age of the electronic system and environmental stress. The calculation of the remaining useful life (abbreviated as RUL below) of an electronic system is a key step in the predictive maintenance process. The RUL is realized on the basis of a failure model (empirical or physical model) and/or device or component operation and environment conditions.

As shown in FIG. 1, a failure rate curve of an electronic unit for an electronic system in the prior art may be divided into three stages: an early failure stage, a random failure stage, and an exhaustion failure stage. The “early failure stage” is defined as faults that occur in an early stage after the electronic unit begins operating; faults that occur during the “random failure stage” can generally be attributed to randomly occurring excessive stress, such as power surges; and the “exhaustion failure stage” occurs due to fatigue and exhaustion of the natural life of the electronic unit-when the electronic unit enters the exhaustion phase, the failure rate will often increase rapidly.

Taking into account the inherent characteristics of an electronic unit, the life of an electronic system using the electronic unit may be predicted, so as to learn the useful life of the electronic system. One technical solution disclosed in the prior art uses a sensor to collect data and predicts life on the basis of an aging model. Another technical solution disclosed in the prior art first uses data collected from a sensor, and then assesses the remaining life of a device on the basis of an algorithm associated with acceleration factors of operation and environment conditions.

Existing calculation methods focus on using acceleration factors to perform calculation, but aging is a comprehensive, complex process, and simple acceleration factors struggle to accurately describe the aging process.

### SUMMARY

Teachings of the present disclosure provide methods and apparatus for calculating the remaining useful life of an electronic system, which are able to ensure the reliability of a product using the electronic system through precise calculation of the remaining useful life of the electronic system. For example, some embodiments include a method for calculating the remaining useful life of an electronic system, the method comprising: determining multiple degradation distribution models of the electronic system on the basis of historical data, wherein the historical data comprises a measurement value, at each measurement time point, for each of multiple electronic units of a first type used for the electronic system, the measurement value corresponding to a characteristic parameter in the electronic unit of the first type, the characteristic parameter representing a degradation level of the electronic system, and each of the degradation distribution models corresponds to one measurement time point; processing the historical data on the basis of a proportional hazards degradation model, to obtain a reliability function of the electronic unit of the first type; using real-time test data to perform calculation on the basis of a corresponding degradation distribution model, to obtain a degradation index value of the electronic unit of the first type, wherein the real-time test data is a measurement value of the characteristic parameter at a current test time point, and the corresponding degradation distribution model is a degradation distribution model corresponding to the current test time point; and using the degradation index value to calculate the remaining useful life of the electronic system on the basis of the reliability function and the current test time point.

As another example, some embodiments include an apparatus for calculating the remaining useful life of an electronic system, the apparatus comprising: a data collection unit, for collecting a measurement value of a characteristic parameter of each electronic unit of a first type used for the electronic system, wherein the characteristic parameter is used to represent a degradation level of the electronic system, multiple historically accumulated measurement values of each of multiple said electronic units of the first type at multiple measurement time points serve as historical data, and a measurement value of the characteristic parameter collected at a current test time point serves as real-time test data; a controller, for receiving and processing the real-time test data and the historical data from the data collection unit, and performing the following actions: determining multiple degradation distribution models of the electronic system on the basis of the historical data, wherein each of the degradation distribution models corresponds to one measurement time point; processing the historical data on the basis of a proportional hazards degradation model, to obtain a reliability function of the electronic unit of the first type; using the real-time test data to perform calculation on the basis of a corresponding degradation distribution model, to obtain a degradation index value of the electronic unit of the first type, wherein the corresponding degradation distribution model is a degradation distribution model corresponding to the current test time point; and using the degradation index value to calculate the remaining useful life of the electronic system on the basis of the reliability function and the current test time point.

As another example, some embodiments include an apparatus for calculating the remaining useful life of an electronic system, the apparatus comprising: a data collection unit, for collecting a measurement value of a characteristic parameter of each electronic unit of a first type used for the electronic system, wherein the characteristic parameter is used to represent a degradation level of the electronic system, multiple historically accumulated measurement values of a characteristic parameter of each of multiple said electronic units of the first type at multiple measurement time points serve as historical data, and a measurement value of the characteristic parameter collected at a current test time point serves as real-time test data; a cloud processing unit, for receiving and processing the historical data from the data collection unit, and performing the following steps: determining multiple degradation distribution models of the electronic system on the basis of the historical data, wherein each of the degradation distribution models corresponds to one measurement time point; processing the historical data on the basis of a proportional hazards degradation model, to obtain a reliability function of the electronic unit of the first type; a controller, for receiving and processing the real-time test data from the data collection unit, and performing the following: using the real-time test data to perform calculation on the basis of a corresponding degradation distribution model, to obtain a degradation index value of the electronic unit of the first type, wherein the corresponding degradation distribution model is a degradation distribution model corresponding to the current test time point; and using the degradation index value to calculate the remaining useful life of the electronic system on the basis of the reliability function and the current test time point.

As another example, some embodiments include a computer-readable storage medium, comprising an instruction which, when executed, causes a processor of a computer to be at least used for performing one or more of the methods for calculating the remaining useful life of an electronic system as described herein.

As another example, some embodiments include an apparatus for calculating the remaining useful life of an electronic system, the apparatus comprising a processor and a memory, the memory having stored thereon an instruction which, when executed, causes the processor to: perform the method for calculating the remaining useful life of an electronic system as described in any part of the first aspect.

### BRIEF DESCRIPTION OF THE DRAWINGS

Example embodiments of the teachings of the present disclosure are described in detail below with reference to the drawings, to give those skilled in the art a clearer understanding of the abovementioned and other features and potential advantages. In the drawings:

FIG. 1 is a schematic drawing of a failure rate curve of an exemplary electronic unit;

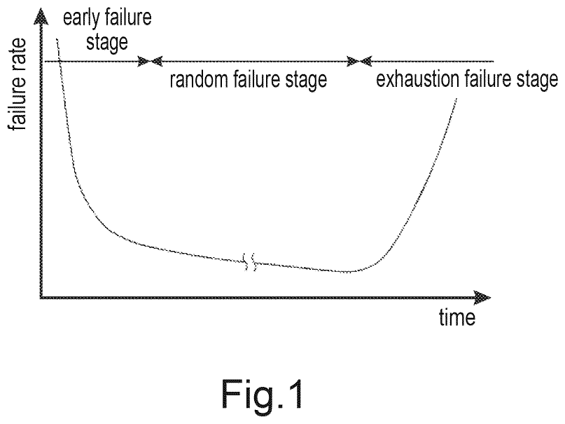

FIG. 2a is a schematic flow chart of the method for calculating the remaining useful life of an electronic system incorporating teachings of the present disclosure;

FIG. 2b is a flow chart of an example implementation of the method for calculating the remaining useful life of an electronic system incorporating teachings of the present disclosure;

FIG. 3 is historical data of an exemplary electronic unit incorporating teachings of the present disclosure;

FIG. 4 is multiple degradation distribution models of electronic units determined using the historical data shown in FIG. 3;

FIG. 5 is failure rate curves of multiple electronic units obtained by calculation using the historical data shown in FIG. 3;

FIG. 6 is failure rate curves of multiple electronic units obtained by fitting using the historical data shown in FIG. 3;

FIG. 7 is a reliability curve formed by a reliability function obtained by processing the historical data shown in FIG. 3 on the basis of a proportional hazards degradation model incorporating teachings of the present disclosure;

FIG. 8 is estimated life at different measurement time points, calculated using a reliability function and corresponding degradation distribution models shown in FIG. 4;

FIG. 9 is an RUL graph obtained by an example method for calculating the remaining useful life of an electronic system incorporating teachings of the present disclosure using the historical data shown in FIG. 3;

FIG. 10 is a schematic drawing of a first example of the apparatus for calculating the remaining useful life of an electronic system incorporating teachings of the present disclosure;

FIG. 11 is a schematic drawing of a second example of the apparatus for calculating the remaining useful life of an electronic system incorporating teachings of the present disclosure; and

FIG. 12 is a schematic drawing of a third example of the apparatus for calculating the remaining useful life of an electronic system incorporating teachings of the present disclosure.

### DETAILED DESCRIPTION

To enable a clearer understanding of the technical features, objective and effects of the teachings of the present disclosure, particular embodiments are now described with reference to the drawings, in which identical labels indicate structurally identical components or structurally similar but functionally identical components. In this text, “schematic” means “serving as an instance, an example or an illustration”. No drawing or embodiment described as “schematic” herein should be interpreted as a more preferred or more advantageous technical solution.

To make the drawings appear uncluttered, only those parts relevant to embodiments of the present application are shown schematically in the drawings; they do not represent the actual structure thereof as a product. Furthermore, to make the drawings appear uncluttered for ease of understanding, in the case of components having the same structure or function in certain drawings, only one of these is drawn schematically, or only one is marked.

In this text, “a” does not only mean “just this one”, but may also mean “more than one”. In this text, “multiple” means two or more (i.e. including two).

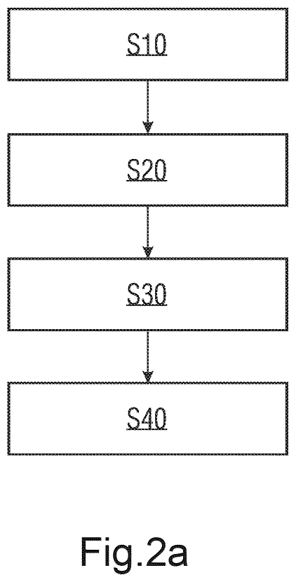

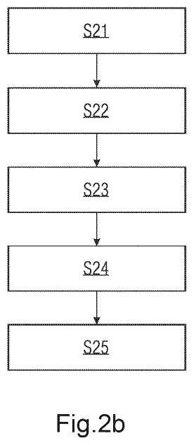

FIGS. 2a and 2b show a schematic flow chart of an example method for calculating the remaining useful life of an electronic system incorporating teachings of the present disclosure. As shown in FIG. 2a, the method comprises elements S10 to S40 below.

S10: determining multiple degradation distribution models of the electronic system on the basis of historical data. The historical data comprises a measurement value, at each measurement time point, for each of multiple electronic units of a first type used for the electronic system, wherein the measurement value corresponds to a characteristic parameter in the electronic unit of the first type, the characteristic parameter representing a degradation level of the electronic system. Each degradation distribution model corresponds to one of multiple measurement time points.

Taking as an example the case where electronic units of the same type used for an electronic system are the electronic units of the first type: in the case of these electronic units, the performance of the electronic units and electronic elements in the electronic units will degrade due to stress during operation. Therefore, we may consider monitoring and recording certain information as characteristic parameters of the electronic system, said information being associated with representing the degradation level of the electronic system. Examples are voltage changes and/or current changes of one or more key electronic elements of the electronic unit at different measurement time points. The key component might be the most important component in the electronic unit or the component with the shortest mean time to failure (abbreviated as MTTF below); a fault thereof will result in failure of the electronic unit.

For example, at least one key characteristic parameter of the electronic system is at least one of a voltage change value, a current change value, an operating temperature change value and an operating humidity value of a key electronic element in the electronic unit mentioned above. When enough historical data has been recorded, different degradation distribution models corresponding to different measurement time points can be obtained.

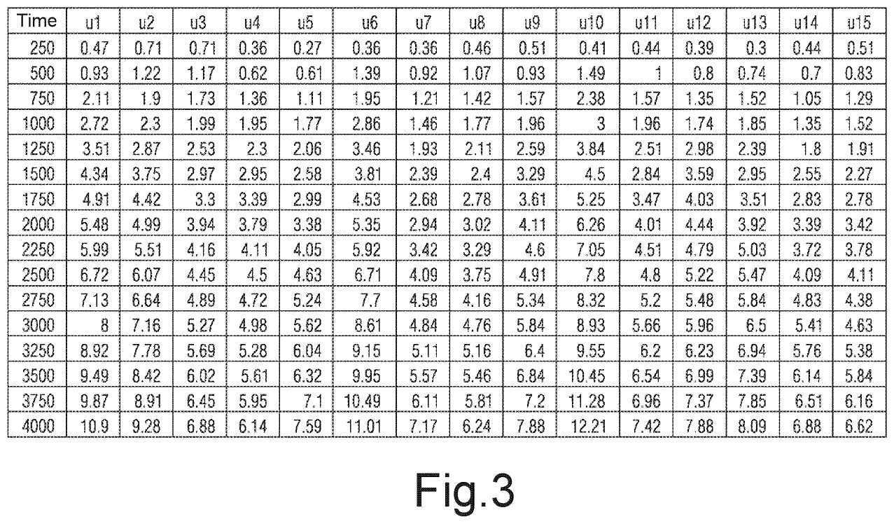

Step S10 may include subjecting a portion of historical data to data fitting to form a corresponding degradation distribution chart. In some embodiments, the portion of historical data is all measurement values corresponding to one of multiple measurement time points in the historical data. For example, in the historical data shown in FIG. 3, when the historical data comprises measurement values of 15 electronic units of the same type at 16 measurement time points, 15 measurement values at each measurement time point are subjected to data fitting to form a corresponding degradation distribution chart.

Secondly, one or more distribution models is/are determined on the basis of the degradation distribution chart. In actual use, due to the complexity of the degradation mechanism, it is not appropriate to use only one probability distribution model to determine different degradation distribution charts corresponding to different measurement time points; therefore, multiple types of existing probability distribution models may be used to assess these degradation distribution charts. For example, a normal distribution model, lognormal distribution model, Weibull distribution model or gamma distribution model, etc. may be used.

Thirdly, in the case where there are multiple types of distribution models, the KL divergence method is used to compare the degrees of proximity of different distribution models, so as to determine a degradation distribution model corresponding to a portion of the historical data. Suppose that a degradation distribution chart formed for a particular measurement time point may be determined as multiple types of distribution model; then the KL divergence method may be used to compare the differences between different distribution models, so as to determine the most logical degradation distribution model.

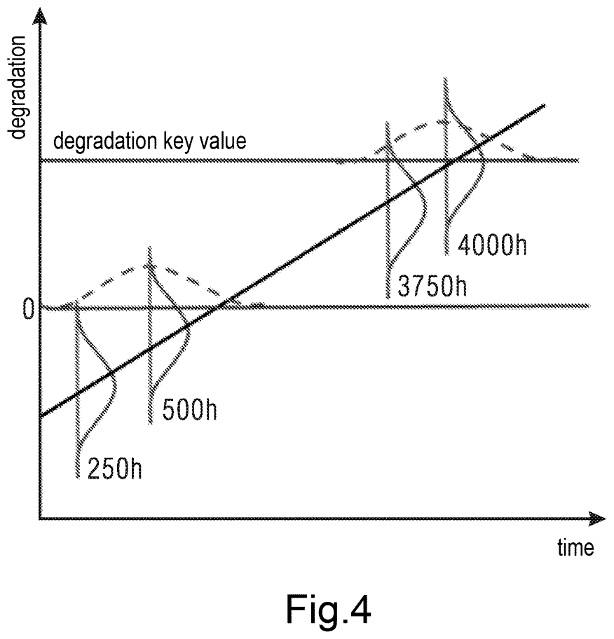

In some embodiments, S10 includes subjecting a portion of the historical data to data fitting on the basis of a nonparametric method, to determine a degradation distribution model. Multiple degradation distribution models similar to those shown in FIG. 4 may thereby be formed, each degradation distribution model corresponding to one measurement time point.

S20: processing the historical data on the basis of a proportional hazards degradation model (abbreviated as PHDM below), to obtain a reliability function of the electronic unit of the first type. The PHDM is an expansion and modification of a typical reliability matrix and a Cox proportional hazards model. As shown in FIG. 2b, in some embodiments, S20 comprises the following:

S21: based on the PHDM, obtaining a reliability function formula:

$$R ( t ) = 1 - exp ( - q ( t ) \times {\int }_{0}^{{γ}_{DF}} {λ}_{0} ( y ) )$$

where R(t) is the reliability function, q(t) is a covariate function, λ₀(y) is a reference failure rate function of the electronic unit of the first type, y is a measurement value of a characteristic parameter, t is the lifespan of the electronic system, and y_{DE} is a failure threshold of the characteristic parameter.

S22: processing historical data of each electronic unit of the first type, to obtain multiple failure rate values of each electronic unit of the first type.

In some embodiments, taking as an example the case where multiple electronic units of the same type used in an electronic system are the electronic units of the first type, as shown in FIG. 3, when the historical data comprises measurement values of 15 electronic units (e.g. u1, u2, . . . u15) at 16 different measurement time points, 15 measurement values at each measurement time point are processed by a nonparametric method, to obtain M failure rate values of the electronic units.

S23: subjecting all of the failure rate values to fitting processing to form a covariate function q (t) by subjecting all of the failure rate values of all of the electronic units of the first type to calculation using the following formula, t to obtain proportional coefficient values:

$$k ( {t}_{j} ) = \frac{1}{M} {\sum }_{i = 1}^{M} ( \frac{{h}_{j} ( {y}_{ij} )}{{h}_{0} ( {y}_{i 0} )} )$$

where tⱼ is a specific measurement time point (j=1, 2, . . . . N), N is the total number of measurement time points, M is the total number of failure rate values obtained by calculation from all measurement values at each measurement time point, hⱼ (yᵢⱼ) is the ith failure rate value at measurement time point tⱼ, and h₀(V₁₀) is the ith failure rate value at a set reference measurement time point to; then separately processing the calculated N proportional coefficient values to obtain N data points relating to measurement time points and proportional coefficient values.

Finally, the N data points are subjected to curve fitting to obtain the covariate function q (t).
S24: processing a portion of all of the failure rate values, and calculating ∫₀^{ybr}λ₀(y), letting λ₀(y)=h₀(y₁₀).
S25: using the covariate function q(t) and ∫₀^{ybr}λ₀(y) to obtain a reliability function of the electronic unit of the first type on the basis of the reliability function formula.
S30: using real-time test data to perform calculation on the basis of a corresponding degradation distribution model, to obtain a degradation index value of the electronic unit of the first type. In some embodiments, the real-time test data is a measurement value of a characteristic parameter at a current test time point, and the corresponding degradation distribution model is a degradation distribution model corresponding to the current test time point. Firstly, based on the current test time point, a corresponding degradation distribution model is determined. Secondly, based on the corresponding degradation distribution model, a degradation index value corresponding to real-time monitoring data is calculated. Taking as an example the case where multiple electronic units of the same type used in an electronic system are the electronic units of the first type, the current test time point tₚ is used to select a corresponding degradation distribution model, according to the degradation distribution models of electronic units at different measurement time points shown in FIG. 4. Next, based on the selected degradation distribution model, real-time monitoring data is used to calculate a degradation index value r corresponding to the real-time monitoring data.
S40: using the degradation index value r to calculate the RUL of the electronic system on the basis of the reliability function R(t) and the current test time point tₚ. Firstly, setting the reliability function of the electronic unit of the first type R(t)=r; secondly, using the reliability function R(t) of the electronic unit of the first type to obtain a lifespan tᵣ; thirdly, obtaining the RUL (tᵣ-tₚ) of the electronic system on the basis of the difference between the lifespan tᵣ and the current test time point tₚ.

The calculation methods described herein can assess the operating reliability of a product using an electronic system more precisely. In view of the fact that the disclosed calculation method can determine the RUL of an electronic system, the method can serve as important information for making decisions in relation to predictive maintenance or state-based maintenance.

In addition, since the disclosed calculation method takes into account the variability and real-time degradation of different electronic units among electronic units of the same type, the method has very high accuracy. Usually, a single product does not obey a group-based model, and there is a marked difference in reliability between a group of products and single products. In the calculation method disclosed in embodiments of the present application, a “Bayesian inference” algorithm for example is used to provide a reliability assessment for single products by integrating group degradation information and individual degradation data. In this text, group degradation data comprises not only group statistical information but also variation among individuals in the group.

At the same time, the disclosed calculation methods can be incorporated in the design of new products at a low cost, because software integrating the calculation method can be implemented in a CPU of a current version of an electronic unit very easily, and hardware for realizing the method does not require a large number of devices.

The disclosed calculation methods may include degradation statistical information, so the method is a more effective technique for assessing reliability. In the case of products with a longer life, degradation data is easier to obtain than failure data.

Applications of the disclosed calculation methods may be expanded to other products, such as residual current protectors (abbreviated as RCD) or are fault detecting devices (abbreviated as AFDD), to enable these electrical products to monitor the degree of aging of sensitive elements thereof using the disclosed calculation method, with almost no adjustment needed.

In some embodiments, historical data with different stresses (including environmental parameters and operating parameters) may be used as an input source without the need for any equivalent conversion (for example, data at different temperatures should be converted to equivalent data at 25° C.); that is to say, the disclosed calculation method can calculate the RUL of an electrical product quickly and effectively.

FIGS. 3-9 depict embodiments of the use of example methods incorporating teachings of the present disclosure for calculating the RUL of an electronic system. As shown in FIG. 3, this embodiment presents a specific application scenario of the method, taking electronic units of the same type used for an electronic system as an example. In this embodiment, operating current increase percentages, at operating temperature, of the same key electronic element in 15 electronic units of the same type are collected as characteristic parameters-operating current increase percentages collected at 16 measurement time points (e.g. 250 hours, 500 hours, 750 hours . . . 4000 hours) of operation of the 15 electronic units (u1, u2, . . . u15).

Firstly, the 15 operating current increase percentages at each measurement time point (e.g. 250 hours) are subjected to data fitting, to form a degradation distribution chart corresponding to 250 hours. In this embodiment, a nonparametric method is used to subject the 15 measurement values at each measurement time point to data fitting, to determine a degradation distribution model corresponding to a portion of the historical data.

Continuing in this fashion, degradation distribution models respectively corresponding to the 16 measurement time points of the electronic units are determined. FIG. 4 only shows degradation distribution models corresponding to a portion of the measurement time points (e.g. 250 hours, 500 hours, 3750 hours and 4000 hours). A nonparametric method is then used to process the historical data on the basis of a PHDM, to obtain a reliability function of the electronic units of the first type.

Firstly, the following formula is used to calculate multiple failure rate values of the electronic units of the first type:

$$h ( t ) = \frac{f ( t )}{R ( t )} = \frac{{lim}_{Δ t \to 0} [ x ( t + Δ t ) - x ( t ) ] / Δ t / A}{[ A - x ( t ) ] / A}$$

where f(t) is a probability density function of life distribution of the electronic units of the first type, A is the total number of electronic units of the first type, and x is the number of electronic units of the first type which have failed up till t.

Specifically, the historical data shown in FIG. 3 is processed, so as to calculate failure rate values of multiple electronic units on the basis of variation of the formula above. For M items of data at tⱼ, the maximum and minimum values thereof are chosen as upper and lower limits to form an interval, which comprises a number of data points, such that the difference A between any two adjacent data points in the interval is the same. Next, a number of sub-intervals are formed from the interval, the upper and lower limits of each sub-interval being two adjacent data points in the interval. Next, the number xₖⱼ of the M items of data that fall into each sub-interval is counted, wherein xₖⱼ is the number of measurement values that fall into the kth sub-interval at the jth measurement time point.

For example, for the 15 items of data at 250 h (hours), the maximum and minimum values thereof are chosen to form the interval [0.27, 0.71]; this interval comprises 6 items of data, the 6 items of data comprising the maximum and minimum values mentioned above, and the other 4 data points are calculated so that the difference A between any two adjacent data points is the same. In this embodiment, this first interval [0.27, 0.71] comprises 6 data points: 0.27, 0.358, 0.446, 0.534, 0.622 and 0.71, wherein Δ=0.088.

Next, based on the 6 data points in the interval, 5 sub-intervals are determined, the upper and lower limits of each sub-interval being two adjacent data points in the interval (for example, [0.27, 0.358], [0.358, 0.446], [0.446, 0.534], [0.534, 0.622], [0.622, 0.71]). The numbers xₖ₁ of the abovementioned 15 items of data that respectively belong to the 5 sub-intervals are counted, wherein xₖ₁ is the number of parameter values that fall into the kth sub-interval at the jth measurement time point (for example, x₁₁=2, x₂₁=7, x₃₁=4, x₄₁=0, x₅₁=2). 5 failure rate values for 250 h (hours) are thereby calculated according to the following formula:

$${h}_{1} ( {x}_{k 1} ) = \frac{{x}_{k 1}}{( A ‐ SUM ( 0 : {x}_{( k - 1 ) 1} ) \cdot Δ} ( i = 1 , 2 , … , 5 ) ;$$

where Xii is the number of parameter values that fall into the ith sub-interval at the 1st measurement time point (e.g. 250 h), x₍₁₋₁₎₁ is the number of parameter values that fall into the (i-1)th sub-interval at the 1st measurement time point (250 h), and A is the total number of electronic units.

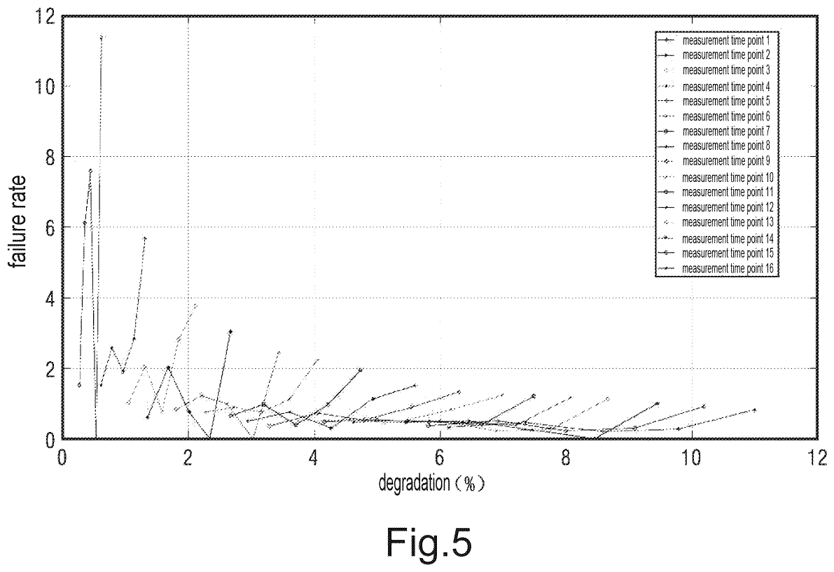

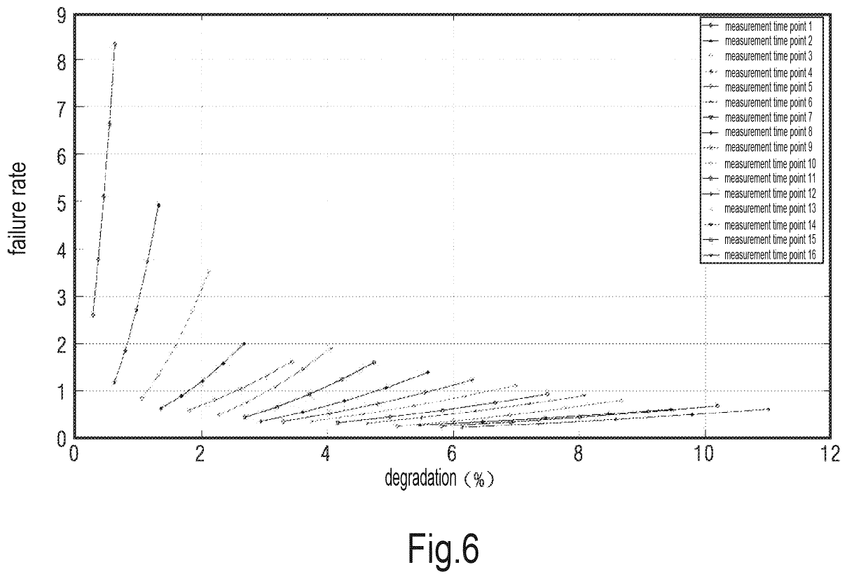

FIG. 5 shows failure rate curves for different measurement time points (e.g. 250 hours (measurement time point 1), 500 hours (measurement time point 2) . . . 3750 hours (measurement time point 15) and 4000 hours (measurement time point 16)), obtained according to the abovementioned algorithm. The method of least squares is used to subject the failure rate curves of the multiple electronic units shown in FIG. 5 to curve fitting, thereby forming the failure rate curves of the multiple electronic units obtained by fitting which are shown in FIG. 6.

Next, all of the failure rate values of all of the electronic units are subjected to calculation using the following formula, to obtain proportional coefficient values:

$$k ( {t}_{j} ) = \frac{1}{M} {\sum }_{i = 1}^{M} ( \frac{{h}_{j} ( {y}_{ij} )}{{h}_{0} ( {y}_{i 0} )} ) ;$$

where tⱼ is the specific measurement time point (j=1, 2, . . . . N), N is the total number of measurement time points, M is the total number of failure rate values obtained by calculation from all measurement values at each measurement time point, hⱼ (yᵢⱼ) is the ith failure rate value at measurement time point tⱼ, and h₀(y₁₀) is the ith failure rate value at a set reference measurement time point to; in this example, the reference measurement time point to may be set as 2000 h (hours), i.e. h₀(y₁₀) is the ith failure rate value at 2000 h.

Next, the N proportional coefficient values obtained by calculation are separately processed to obtain N data points relating to measurement time points and proportional coefficient values; and the N data points are subjected to curve fitting to obtain a covariate function q(t). In this example, the N proportional coefficient values are separately processed to obtain N data points (tⱼ, Ink (tⱼ)), then these N data points (tⱼ, Ink (t₁)) are subjected to primary curve fitting to form the covariate function q(t).

Next, a nonparametric method is used to process the corresponding failure rate values, so as to obtain ∫₀^{ybr}λ₀(y); the specific operations are as follows: In this embodiment, λ₀(y)=h₀(y₁₀). A reliability function based on the historical data shown in FIG. 3 is thereby obtained:

$$R ( t ) = 1 - exp \frac{- 10.364}{exp ( 0.001659 t - 4.21051 )} ) .$$

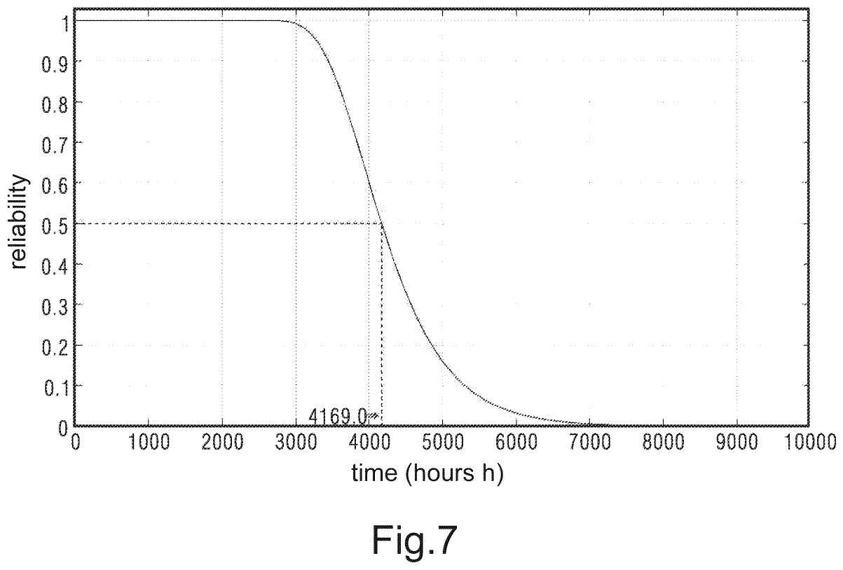

FIG. 7 shows a reliability curve formed on the basis of the reliability function above. Moreover, using this reliability function, the MTTF value of this batch of electronic units can be obtained (i.e. MTTF=4169 h). Again, real-time test data is used to perform calculation on the basis of a corresponding degradation distribution model, to obtain a degradation index value of the electronic units.

In this example, the multiple degradation distribution models shown in FIG. 4 are used to find the degradation distribution model corresponding to measurement time point 1000 h, and the degradation index value for 1000 h is thereby calculated as 0.92.

Finally, the RUL of the electronic system is calculated on the basis of the reliability function R (t) and the current test time point tₚ (tₚ=1000), using the degradation index value r(r=0.92). Specifically, letting R (t)=0.92, it can be determined from the calculated reliability function above that t=3700 h. That is to say, the useful life tᵣ of this batch of electronic units obtained on the basis of the reliability function is 3700 h.

The MTTF obtained on the basis of FIG. 7 is 4169 h, and the useful life of the electronic system using the electronic units according to actual statistics is 3750 h-4000 h; thus, it can be seen that the useful life of the electronic system calculated according to the teachings of the present disclosure is both more accurate and more precise.

Next, the RUL of the electronic system is obtained, based on the difference between the lifespan tᵣ and the current test time point tₚ. That is to say, this embodiment calculates that the RUL of the electronic system is 2700 h when the current test time point tₚ is 1000 h.

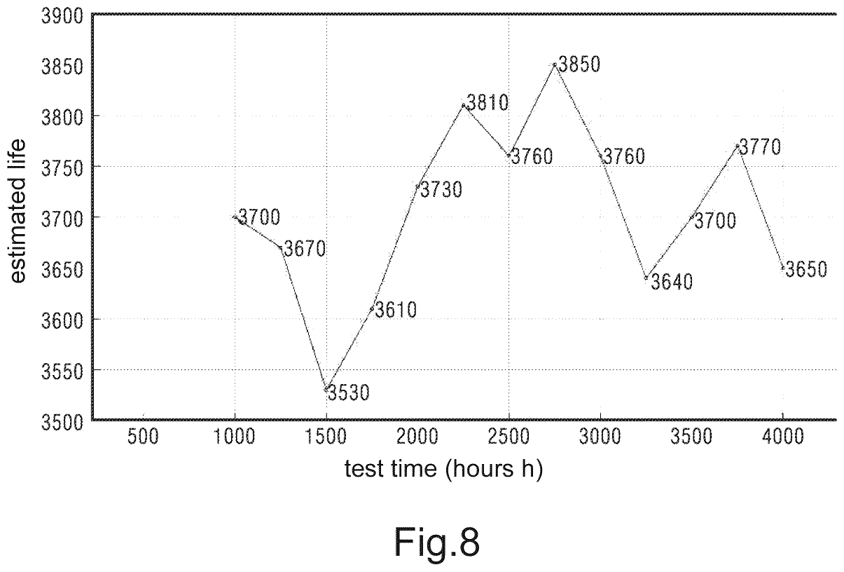

FIG. 8 shows a useful life curve of the electronic system using the electronic units, obtained at different measurement time points, and calculated using the method disclosed in embodiments of the present application on the basis of the historical data of FIG. 3 and real-time test data.

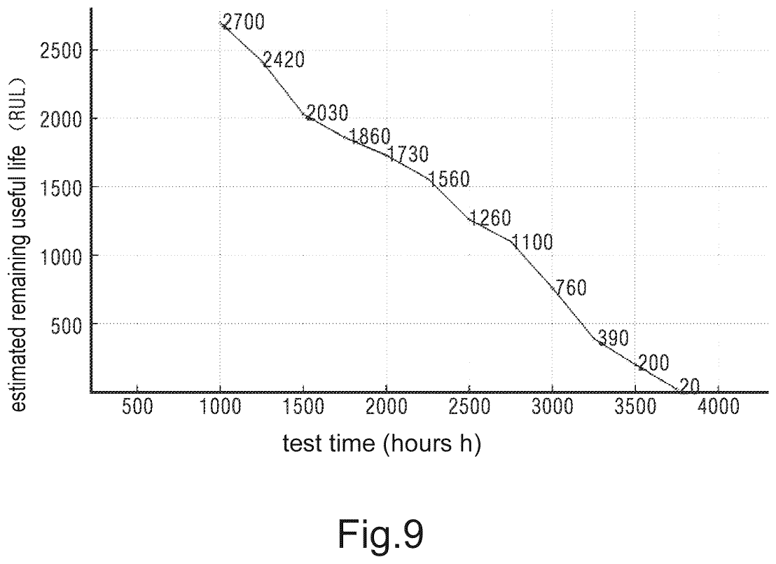

Moreover, FIG. 9 shows an RUL curve of the electronic system using the electronic units, obtained at different measurement time points, and calculated using the methods described herein on the basis of the historical data of FIG. 3 and real-time test data.

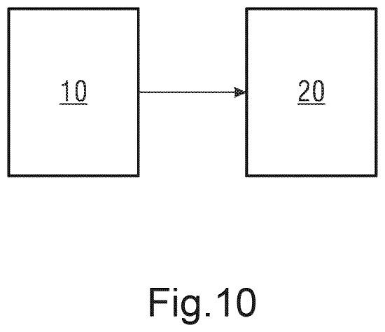

In addition, some embodiments include an apparatus for calculating the RUL of an electronic system. In an example as disclosed in FIG. 10, the disclosed apparatus comprises: a data collection unit 10 and a controller 20. In this example, the data collection unit 10 is used to collect a measurement value of at least one characteristic parameter of each electronic unit of a first type that is used for an electronic system. Specifically, the characteristic parameter is used to represent a degradation level of the electronic system; multiple historically accumulated measurement values of characteristic parameter of each of multiple electronic units of the first type at multiple measurement time points serve as historical data, and the measurement value of the characteristic parameter collected at the current test time point serves as real-time test data.

In this example, the controller 20 is used to receive and process real-time test data and historical data from the data collection unit 10, and then perform steps S10-S40 as shown in FIGS. 2a and 2b. The specific operating process by which the controller 20 performs steps S10-S40 is similar to the description above of the disclosed calculation of the RUL of an electronic system, so is not described again here.

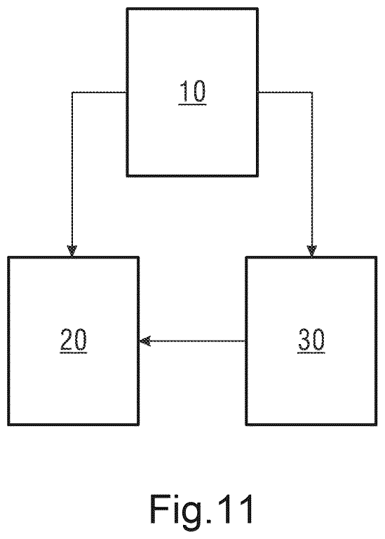

As shown in FIG. 11, another example of an apparatus for calculating the RUL of an electronic system is disclosed. In this example, the apparatus comprises: a data collection unit 10, a controller 20 and a cloud processing unit 30. In this example, the data collection unit 10 is used to collect a measurement value of a characteristic parameter of each electronic unit of a first type that is used for an electronic system. Specifically, the characteristic parameter is used to represent a degradation level of the electronic system; multiple historically accumulated measurement values of a characteristic parameter of each of multiple electronic units of the first type at multiple measurement time points serve as historical data, and the measurement value of the characteristic parameter collected at the current test time point serves as real-time test data.

In this example, the cloud processing unit 30 is used to receive and process historical data from the data collection unit 10, so as to perform steps S10 and S20 shown in FIGS. 2a and 2b. The controller 20 is used to receive and process real-time test data from the data collection unit 10, so as to perform steps $30 and S40 shown in FIG. 2a.

In this example, the cloud processing unit 30 sends all of the received degradation distribution models and the reliability function of the electronic units of the first type to the controller 20, so that the controller 20 applies real-time test data from the data collection unit 10 to the corresponding degradation distribution model and the reliability function of the electronic units of the first type, to calculate the RUL of the electronic system.

In addition, the disclosed method for calculating the RUL of an electronic system can be realized by means of a computer program product. The computer program product may comprise a computer-readable storage medium, carrying computer-readable program instructions for executing various aspects of the content of the present disclosure. The computer-readable storage medium may be a tangible device capable of maintaining and storing instructions used by an instruction execution device. The computer-readable storage medium may for example be, but is not limited to being, an electrical storage device, a magnetic storage device, an optical storage device, an electromagnetic storage device, a semiconductor storage device, or any suitable combination of the above.

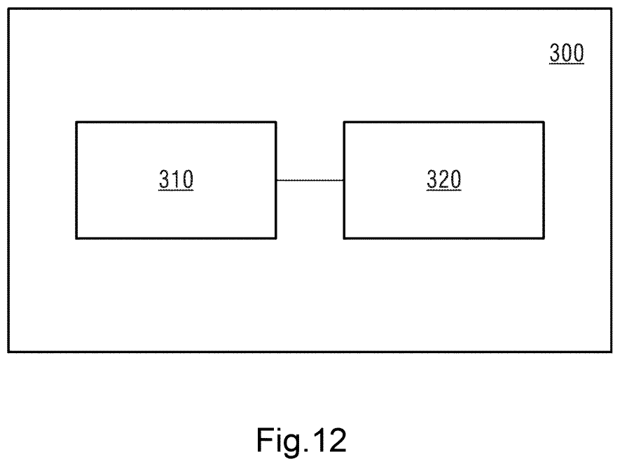

In addition, as shown in FIG. 12, some example embodiments include an apparatus 300 for calculating the RUL of an electronic system. The apparatus 300 comprises a processor 310 and a memory 320. Specifically, the processor 310 may perform S10-S40 as shown in FIGS. 2a and 2b according to computer program instructions stored in the memory 320. The specific operating process by which the processor 310 performs S10-S40 is similar to the description above of the disclosed calculation of the RUL of an electronic system, so is not described again here.

It should be understood that although the description herein is based on various embodiments, it is by no means the case that each embodiment contains only one independent technical solution; this manner of presentation is adopted herein purely for the sake of clarity. Those skilled in the art should consider the Description in its entirety; the technical solutions in different embodiments may also be suitably combined to form other embodiments understandable to those skilled in the art. The series of detailed descriptions above are merely specific descriptions of feasible embodiments of the content of the present disclosure, and are not intended to limit the scope of protection of the content of the present disclosure. All equivalent embodiments or changes made without departing from the artistic spirit of the content of the present disclosure, such as feature combinations, divisions or repetitions, shall be included in the scope of protection of the content of the present disclosure.

What is claimed is:

1. A method for calculating the remaining useful life of an electronic system, the method comprising:
determining multiple degradation distribution models of the electronic system using historical data, wherein the historical data comprises a measurement value, at multiple measurement time points, for each of a multiplicity of electronic units of a first type, the measurement value corresponding to a characteristic parameter in respective electronic unit of the first type, the characteristic parameter representing a degradation level of the electronic system, wherein each of the degradation distribution models corresponds to one measurement time point;
processing the historical data using a proportional hazards degradation model, to obtain a reliability function for electronic units of the first type;
using real-time test data to perform calculation fusing a corresponding degradation distribution model to obtain a degradation index value for electronic units of the first type, wherein the real-time test data comprises a measurement value of the characteristic parameter at a current test time point, and the corresponding degradation distribution model comprises a degradation distribution model corresponding to the current test time point; and
using the degradation index value to calculate the remaining useful life of the electronic system using the reliability function and the current test time point.

2. The method as claimed in claim 1, wherein determining multiple degradation distribution models of the electronic system on the basis of historical data comprises:
subjecting a portion of the historical data to data fitting to form a corresponding degradation distribution chart, wherein said portion of the historical data is all measurement values at one of the multiple measurement time points in the historical data;
determining one or more distribution models using the degradation distribution chart; and
in the case where there are multiple distribution models, using a KL divergence method to compare degrees of proximity of different distribution models, so as to determine the degradation distribution model corresponding to said portion of the historical data.

3. The method was claimed in claim 1, wherein determining multiple degradation distribution models of the electronic system on the basis of historical data comprises:
subjecting a portion of the historical data to data fitting using a nonparametric method; and
determining the degradation distribution model corresponding to said portion of the historical data;
wherein said portion of the historical data is all measurement values at one of the multiple measurement time points in the historical data.

4. The method as claimed in claim 1, wherein processing the historical data on the basis of a proportional hazards degradation model, to obtain a reliability function of the electronic unit of the first type, comprises:
based on a proportional hazards degradation model, obtaining a reliability function formula:
$$R ( t ) = 1 - exp ( - q ( t ) \times {\int }_{0}^{{γ}_{DF}} {λ}_{0} ( y ) ) ,$$
where R(t) is a reliability function, q(t) is a covariate function, λ₀(y) is a reference failure rate function of the electronic unit of the first type, y is a measurement value of the characteristic parameter, t is the lifespan of the electronic system, and y_{DF} is a failure threshold of the characteristic parameter;
processing the historical data of each of the electronic units of the first type, to obtain multiple failure rate values of each of the electronic units of the first type;
subjecting all of the failure rate values to fitting processing to form the covariate function q(t);
processing a portion of all of the failure rate values, and calculating ∫₀^{ybr}λ₀(y); and
using the covariate function q(t) and ∫₀^{ybr}λ₀(y) to obtain a reliability function of the electronic unit of the first type using the reliability function formula.

5. The method was claimed in claim 1, wherein using real-time monitoring data to perform calculation on the basis of a corresponding degradation distribution model to obtain a degradation index value of the electronic unit of the first type, comprises:
determining the corresponding degradation distribution model on the basis of the current test time point; and
calculating a degradation index value corresponding to the real-time monitoring data using the corresponding degradation distribution model.

6. The method as claimed in claim 4, wherein using the degradation index value to calculate the remaining useful life of the electronic system on the basis of the reliability function and the current test time point, comprises:
setting the reliability function R(t) of the electronic unit of the first type to be equal to the degradation index value;
using the reliability function R (t) of the electronic unit of the first type to obtain a lifespan tᵣ; and
obtaining the remaining useful life of the electronic system on the basis of the difference between the lifespan tᵣ and the current test time point.

7. The method as claimed in claim 4, wherein subjecting all of the failure rate values to fitting processing to form the covariate function q(t) further comprises:
subjecting all of the failure rate values of all of the electronic units of the first type to calculation using the following formula, to obtain proportional coefficient values:
$$k ( {t}_{j} ) = \frac{1}{M} {\sum }_{i = 1}^{M} ( \frac{{h}_{j} ( {y}_{ij} )}{{h}_{0} ( {y}_{i 0} )} )$$
where tⱼ is a specific measurement time point (j=1, 2, . . . , N), N is the total number of measurement time points, M is the total number of the failure rate values obtained by calculation from all of the measurement values at each of the measurement time points, hⱼ (yᵢⱼ) is the ith failure rate value at measurement time point tⱼ, and h₀(y₁₀) is the ith failure rate value at a set reference measurement time point to;
separately processing the calculated N proportional coefficient values to obtain N data points relating to measurement time points and proportional coefficient values; and
subjecting the N data points to curve fitting to obtain the covariate function q(t).

8. An apparatus for calculating the remaining useful life of an electronic system, the apparatus comprising:
a data collection unit to collect a measurement value of a characteristic parameter of each electronic unit of a first type used for the electronic system wherein the characteristic parameter represents a degradation level of electronic system, multiple the historically accumulated measurement values of each of multiple said electronic units of the first type at multiple measurement time points serve as historical data, and a measurement value of the characteristic parameter collected at a current test time point serves as real-time test data;
a controller, to:
process the real-time test data and the historical data from the data collection unit;
determine multiple degradation distribution models of the electronic system on the basis of the historical data, wherein each of the degradation distribution models corresponds to one measurement time point;
process the historical data on the basis of a proportional hazards degradation model to obtain a reliability function of the electronic unit of the first type;
use the real-time test data to perform calculation using a corresponding degradation distribution model, to obtain a degradation index value of the electronic unit of the first type, wherein the corresponding degradation distribution model is a degradation distribution model corresponding to the current test time point; and
use the degradation index value to calculate the remaining useful life of the electronic system on the basis of the reliability function and the current test time point.

9. The apparatus as claimed in claim 8, wherein in processing the historical data on the basis of a proportional hazards degradation model to obtain a reliability function of the electronic unit of the first type comprises:
based on the proportional hazards degradation model, obtaining a reliability function formula:
$$R ( t ) = 1 - exp ( - q ( t ) \times {\int }_{0}^{{γ}_{DF}} {λ}_{0} ( y ) ) ,$$
where R(t) is a reliability function, q(t) is a covariate function, λ₀(y) is a reference failure rate function of the electronic unit of the first type, y is a measurement value of the characteristic parameter, t is the lifespan of the electronic system, and y_{DE} is a failure threshold of the characteristic parameter;
processing the historical data of each of the electronic units of the first type, to obtain multiple failure rate values of each of the electronic units of the first type;
subjecting all of the values to fitting processing to form the covariate function q (t);
processing a portion of all of the failure rate values, and calculating ∫₀^{ybr}λ₀(y); and
using the covariate function q(t) and ∫₀^{ybr}λ₀(y) to obtain a reliability function of the electronic unit of the first type on the basis of the reliability function formula.

10. The apparatus as claimed in claim 9, wherein using the degradation index value to calculate the remaining useful life of the electronic system, on the basis of the reliability function and the current test time point, comprises:
setting the reliability function R (t) of the electronic unit of the first type to be equal to the degradation index value;
using the reliability function R(t) of the electronic unit of the first type to obtain a lifespan tᵣ; and
obtaining the remaining useful life of the electronic system on the basis of the difference between the lifespan tᵣ and the current test time point.

11-15. (canceled)
